(19) United States
(12) Patent Application Publication
(10) Pub. No.: US 2006/0146766 A1
(43) Pub. Date: Jul. 6, 2006

(54) Radio terminal session control and interface set up method

(76) Inventors: Masayuki Nakajima, Tokyo (JP); Hidehiko Eguchi, Tokyo (JP); Noriyuki Nakai, Kanagawa (JP); Tomohiro Ubukata, Tokyo (JP)

Correspondence Address: MOTOROLA, INC., 1303 EAST ALGONQUIN ROAD, IL01/3RD, SCHAUMBURG, IL, 60196, US

(21) Appl. No.: 10/546,709

(22) PCT Filed: Feb. 27, 2004
(86) PCT No.: PCT/EP04/50226

§ 371 Date: Aug. 22, 2005

(30) Foreign Application Priority Data
Feb. 28, 2003 (JP) 2003-054996

(51) Int. Cl. H04Q 7/24

(52) U.S. Cl. 370/338

(57) ABSTRACT

A session control method for radio terminals that implements a Multimedia Integrated network by Radio Access Innovation (MIRAI) such that selection of a radio access network does not impose a burden on each of the radio access networks, and an interface setup method for setting up IP connection quickly during switching of the radio access network. The Multimedia Integrated network by Radio Access Innovation (MIRAI) 10 includes heterogeneous radio access networks 11, Internet 12, and multimode radio terminals 13, and the heterogeneous radio access networks 11 includes a PHS network 11a, a wireless LAN 11b, a paging network 11c, and a cellular phone network 11d. The Internet 12 includes a CCN server 12a, which sends session-related information to the radio terminal 13 via the paging network 11c. The radio terminal 13 selects a radio IF and application that are appropriate for communication based on the session-related information, and establishes a session.

### BACKGROUND OF THE INVENTION

The present invention relates to radio terminal session control and interface setup methods.

A Multimedia Integrated network by Radio Access Innovation (MIRAI) has been proposed which connects a plurality of dissimilar radio access networks (RANs), such as, for example, wireless LANs and PHS, through a common core network, to enable seemless communication among those dissimilar radio access networks (Non-patent Reference 1).

The MIRAI comprises, as its architecture, a high-functionality common core network, as signaling network, and a Software Defined Radio (SDR) terminal or multimode radio terminal. It should be appreciated that the multimode radio terminal includes a plurality of interfaces and applications, so that when it is to communicate, it uses a unique ID (numeral or URI, etc.) for specifying the terminal. The SDR terminal or multimode terminal transmits its location information and so forth to the common core network, which selects a radio access network based on that information, and the selected radio access network information is notified to the SDR terminal or multimode terminal, whereby a system for an optimum radio access network is downloaded or alerted to the SDR terminal or multimode terminal.

In other words, with the MIRAI network scheme, management of the radio access network, session, and user information is implemented univocally by the core network, so that a system is assumed where a plurality of radio access networks are integrated closely.

[Non-patent Reference 1] G. Wu, et. al., “MIRAI architecture for heterogeneous networks”, IEEE Comm. Mag., February 2002.

In actuality, however, each of the radio access networks is managed by its respective operator, and it is practically difficult to seamlessly integrate the existing radio access networks and univocally manage them.

More specifically, for communication in the MIRAI network, when a session is to be established, it is necessary to select a radio interface and application suitable for the session. Especially, when a call is made from a terminal, a necessary network may be selected, because the calling party recognizes both the session-related information and the radio access network and application to be used. However, the called terminal cannot know beforehand what type of session is to be established. Thus, it is necessary to activate all the networks, or efficiently select, on the network side, a radio network and application suitable for the media session before the session is established. As a result, each of the radio access networks becomes complicated and enormous in size, so that they are hardly practicable.

When switching is to be made to a dissimilar radio access network while the session is being established, an IP connection is made between an access point of the target radio access network and an access network sever of an Internet service provider, before the previous session parameters are change. Unless the IP connection is made quickly, a problem would occur such that the communication is disconnected and switching to a dissimilar radio access network fails.

The present invention is intended to solve the aforedescribed problem, and has as its objective to provide a radio terminal session control method, where each of the radio access networks is selected by a radio terminal to implement a MIRAI network without burdening each of the radio access networks.

### SUMMARY OF THE INVENTION

The invention described in claim 1 is a session control method for radio terminals used in a Multimedia Integrated network by Radio Access Innovation (MIRAI) that comprises a plurality of dissimilar radio access networks and the Internet that connects the radio access networks, wherein one of the radio access networks is used as a signaling network; a server is provided in the Internet such that when a request for connection with the radio terminal is made, session-related information required for that connection is sent to the signaling network; the radio terminal includes a plurality of radio interfaces and a plurality of applications, as well as an agent portion; and the agent portion allows a radio interface corresponding to the signaling network among a plurality of radio interfaces to be retained in the standby condition, and allows the radio interface in; the standby condition to receive the session-related information, so that and application and radio interface that are suitable for communication are selected among the plurality of application and the plurality of radio interfaces, respectively, based on the session-related information, to establish a session.

The invention described in claim 2 encompasses a session control method for radio terminals according to claim 1, where the agent portion has the function to terminate the session upon completion of the communication and automatically set the radio interface in the idle state when it is no longer needed.

The invention described in claim 3 encompasses an interface setup method for a Multimedia Integrated network by Radio Access Innovation (MIRAI) that comprises a plurality of dissimilar radio access networks and the Internet that connects among said radio access networks, wherein: a server is located in said Internet to acquire ad-hoc authentication information against an access network server of each service provider that makes IP connection respectively with an access point of said radio access network; a radio terminal is equipped with a plurality of radio interfaces, as well as an agent portion; said interface setup method comprising the steps of:

detecting beforehand, by said agent portion, switching of the radio access network, and before switching of the radio access network, sending information related to the target radio access network to said server located in the Internet;

identifying, by said server located in the Internet, said access network server that makes IP connection with the access point of the target radio access network, based on said information related to the target radio access. network; acquiring ad-hoc authentication information against the access network server; and sending information required for the IP connection, together with the ad-hoc authentication information, to said agent portion;

sending, by said agent portion, said ad-hoc authentication information to said access network server, so that said ad-hoc authentication information activates connection with said access network server; and

sending by said agent portion, information required for IP connection to said access network to make IP connection, when connection to said access network server is activated.

(Operation)

According to the invention of claim 1, the radio terminal includes a plurality of radio interfaces, a plurality of applications, and an agent portion, and the agent portion can select a radio interface and application suitable for communication based on session-related information and establish a session, by acquiring session related information from the Internet server via a signaling network. That is, a MIRAI network can be implemented without imposing a burden on each of the radio access networks.

According to the invention described in claim 2, the agent portion included in the radio terminal can terminate the session, upon sensing the completion of the media session established.

According to the invention described in claim 3, before a radio access network is switched, an interface setup for IP connected with the access point of the target radio access network. Thus, the time required for setup for IP connection during switching of a radio access network can be reduced, and the disconnect time based on the switching can be shortened.

### BRIEF DESCRIPTION OF THE DRAWINGS

FIG. 1 is an explanatory diagram for explaining a schematic configuration of a Multimedia Integrated network by Radio Access Innovation (MIRAI) that embodies the present invention.

FIG. 2 is a system architecture diagram for explaining the architecture of a multimode radio terminal.

FIG. 3 is a sequence chart illustrating the process until the multimode radio terminal establishes and terminates a session.

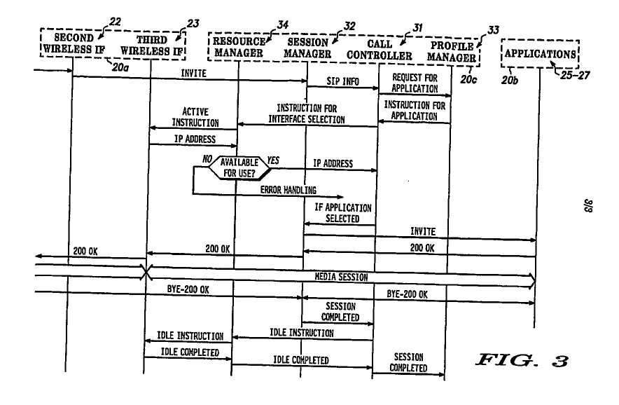

### DETAILED DESCRIPTION OF THE INVENTION

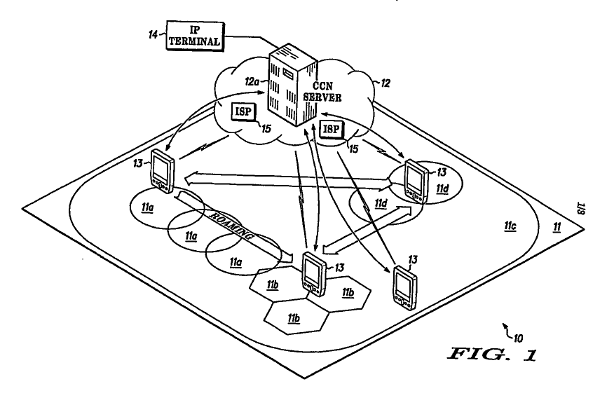

Next, one embodiment of the present invention is described with reference to the drawings. FIG. 1 is an explanatory diagram for explaining a schematic configuration of a Multimedia Integrated network by Radio Access Innovation (MIRAI) that embodies the present invention. In FIG. 1, a MIRAI network 10 is comprised of heterogeneous radio access networks (RANs) 11, Internet 12, and multimode radio terminals (MUT: Multi-service User Terminal) 13. The heterogeneous radio access networks 11 comprise a plurality of dissimilar radio access networks. In the present embodiment, a plurality of dissimilar radio access networks are made up of a PHS (Personal Handyphone System) network 11a, a wireless LAN (WLAN: Wireless Local Area Network) 11b, a paging network (Two-way Paging System) 11c, a cellular phone network 11d, and so forth. In other words, multiple service areas of the respective networks 11a-11d exist over the heterogeneous radio access networks 11.

The Internet 12 is a network for connection among the respective networks 11a-11d over the heterogeneous radio access networks 11, and Internet service providers (ISPs) 15 and CCN server 12a are provided over the Internet 12, which manage connections among the respective networks 11a-11d.

The multimode radio terminal 13, or MUT, communicates over the heterogeneous radio access networks 11, another multimode radio terminal 13 located within the same network 11a-11d or another multimode radio terminal 13 located within another network 11a-11d. Furthermore, the multimode radio terminal 13 communicates with an IP terminal 14, such as an IP phone, via the Internet 12. The multimode radio terminal 13 is a portable radio terminal. While roaming over the heterogeneous radio access networks 11, the multimode radio terminal 13 can communicate with another multimode radio terminal 13 over the respective networks 11a-11d. The multimode radio terminal 13 can also communicate with the IP terminal 14 via the Internet 12, while roaming over the heterogeneous radio access networks 11. Thus, the multimode radio terminal 13 is equipped with respective radio interfaces and multiple applications corresponding to the respective networks 11a-11d, as well as the functionality for controlling them.

The MIRAI network 10 of the present embodiment employs the SIP (Session Initiation Protocol), as a basis to implement a session control protocol for enabling the multimode radio terminal 13 to use the respective networks 11a-11d over the heterogeneous radio access networks 11.

Thus, the CCN server 12a located over the Internet 12 is also equipped with the SIP proxy function for transferring SIP messages and the gateway function for transferring the SIP to a specific radio access network 11a-11d. Furthermore, the IP terminal 14 connected to the Internet 12 is also equipped with the SIP function for communicating with the multimode radio terminal 13.

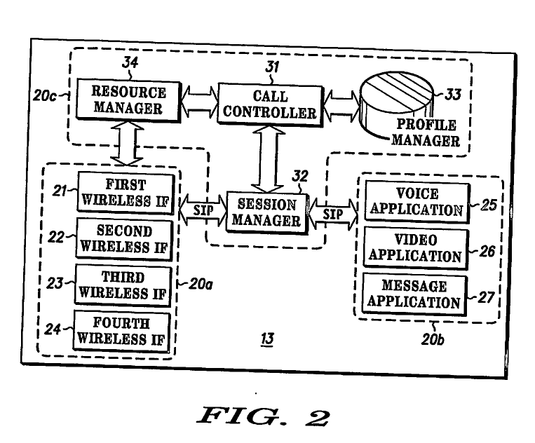

Next, the architecture of the multimode radio terminal 13 is described. FIG. 2 shows a system architecture diagram for explaining the architecture of the multimode radio terminal 13. In FIG. 2, the multimode radio terminal 13 includes an interface portion 20a, an application portion 20b, and an agent portion 20c.

The interface portion 20a includes a PHS radio interface (first radio IF) 21 for the PHS network 11a; a paging radio interface (second radio IF) 22 for the paging network 11c; a wireless LAN radio interface) third radio IF) 23 for the wireless LAN 11b; and a cellular phone radio interface (fourth radio IF) 24 for the cellular phone network 11d.

The application portion 20b includes various voice applications 25 for sending and receiving voice data by use of the network; various video applications 26 for sending and receiving image data by use of the network; various message applications 27 for sending and receiving message data by use of the network; and so forth.

Furthermore, the agent portion 20c includes a call control portion (CC: Call Controller) 31; a session management portion (SM: Session Manager) 32; a profile management portion (PM: Profile Manager) 33; and a resource management portion (RM: Resource Manager) 34.

The session management portion 32 includes a SIP (Session Initiation Protocol) proxy function to interpret a SIP message (INVITE) fed from said first through fourth radio IFs 21-24 and create SIP information required to establish a session, which is then sent to the call control portion 31.

According to the SIP information that is sent from the session management portion 32 and required to establish a session, the call control portion 31 controls the profile management portion 32 and resource management portion 34 to select each of said applications 25-27 and select each of said first through fourth radio IFs 21-24.

The profile management portion 33 store, as a database, information related to said respective applications 25-27 installed in the multimode radio terminal 13. The profile management portion 33 also stores, as a database, information related to user preferences for the applications 25-27 and interfaces.

The resource management portion 34, which is a manager for controlling the respective first through fourth radio IFs 21-24, is designed to make the first through fourth radio IFs 21-24 active or idle in accordance with an instruction from the call control portion 31. The resource management portion 34 also includes the function for monitoring the receiving status (for example, the field strength of the carrier) when the first through fourth radio IF 21-24 is active.

More specifically, when communication is conducted by use of, say, the PHS network 11a, that is, communication is conducted via the first radio IF 21, the resource management portion 34 monitors the receiving status thereof. At that time, if the multimode radio terminal 13 roams beyond the service area of said PHS network 11a (if the communication is likely to be broken due to weaker field strength), the resource management portion 34 issues an instruction to the call control portion 31 before the ongoing communication is disconnected. Then, the resource management portion 32 sets other radio IFs in the standby condition, performs monitoring, and detects the field strength of the other communicable radio access networks for analysis. It then notifies the information on the communicable radio access networks to the call control portion 31.

It should be appreciated that in the present embodiment, the paging network 11c, which has the widest service area among the heterogeneous radio access networks 11, is employed as the signaling radio access network (channel). Thus, when the multimode radio terminal is in the standby condition, the resource management portion 34 only renders active the second radio IF 22 corresponding to the paging network 11c and set it in the standby condition.

The agent portion 20c, which is comprised of the call control portion 31, session management portion 32, and so forth, is designed to perform beforehand interface setup (IP connection) processing conducted between the access point of the destination radio access network and the ISP 15, in order to enable communication over the designation radio access network based on the afore-mentioned information, before the ongoing communication is disconnected.

It should be appreciated that the IP terminal 14, which includes said SIP function, also has a similar agent portion 20c, interface portion 20a and application portion 20b, and their operation is the same; thus their details are not described herein. It should also be appreciated that the IP terminal 14 may have any architecture as far as it has the SIP function, and is not limited to the architecture shown in FIG. 2.

(Establishing a Session)

It should be appreciated that for the sake of simplicity, the IP terminal 14 is a calling party, while the multimode radio terminal 13 is a called party. It should also be appreciated that because the called multimode radio terminal 13 is in the standby condition and the paging network 11c is a signaling channel, only the second radio IF 22 is in the active state.

Let us assume now that the calling IP terminal 14 sends a SIP message (INVITE) to the Internet 12. It should be appreciated that the information contained in the SIP message (INVITE) includes, for example, a call ID for identifying the session; media parameter (voice application, video application, message application, etc.) and a coded type. The DIP message (INVITE) sent to the Internet 12 is transferred to the CCN server 12a over the Internet 12. The CCN server 12a sends said SIP message (INVITE) to the called multimode radio terminal 13 via the paging network 11c as a signaling channel.

When the called multimode radio terminal 13 acquires said SIP message (INVITE) via the second radio IF 22, said SIP message (INVITE) is sent to the session management portion 32. While temporarily storing the information contained in the SIP message (INVITE), the session management portion 32 analyzes it to create SIP information required to establish a session. The SIP information that is created by the session management portion and required to establish a session is transferred to the call control portion 31.

The call control portion 31 selects an application 25-27 for use in communication with the profile management portion 33 in accordance with the SIP information, and acquires information related to user preferences. The call control portion 31 then issues to the resource management portion 34 a selection instruction to select the first through fourth radio IFs 21-24, while sending said information related to user preferences thereto.

The resource management portion 34 selects and renders active one (third radio IFs 21-24, in accordance with the selection instruction, the information related to user preferences, and the receiving conditions of the first through fourth radio IFs 21-24 at that time. When it is rendered active, the resource management portion 34 allows the selected radio IF to send the IP address to the call control portion 31. The call control portion 31 then sends the selected radio IF and application information (IP address and port number) to the session management portion 32.

The session management portion 32 acts as a SIP proxy to transfer said SIP message (INVITE) corresponding to the application 25-27 selected. Upon receiving the SIP message (INVITE), the application 25-27 returns to the session management portion 32 an SIP acknowledgement message (200 OK) that acknowledges said SIP message (INVITE).

The session management portion 32 returns the SIP acknowledgement message (200 OK) via the radio access network selected (wireless LAN 11b, in this case). The SIP acknowledgement message (200 OK) sent from the session management portion 32 to the wireless LAN 11b is transferred to the CCN server 12a over the Internet 12. The CCN server 12a sends said SIP acknowledgement message to the calling IP terminal 14 via the Internet 12.

Subsequently, the calling IP terminal 14 and the session management section 32 of the called multimode radio terminal 13 exchange the SIP message, in a similar manner to the typical SIP, not via the CCN server but via the ISP 15, and establish a session therebetween.

(Terminating a Session)

To terminate a session, A SIP message (BYE) for termination the session is sent from the application of the multimode radio terminal 13 of either the calling or called party. By utilizing the Record Route function of the SIP, the SIP message (BYE) for terminating the session is fed through the session management portion 32.

Upon detecting the SIP message, (BYE) for acknowledging the SIP message (BYE), the session management portion 32 notifies the termination of the session to the call control portion 31. The call control portion 31 refers to the call ID, and sends to the resource management portion 34 an instruction to switch the radio IF (third radio IF 23, in this case) used in the session, from active state to idle state. Upon setting the third radio IF 23 in the idle state, the resource management portion 34 then notifies the call control portion 31 to that effect. The call control portion 31 sends to the profile management portion 33, a notification that the session has been terminated, thereby notifying that the session has been terminated.

Thus, the session between the calling IP terminal 14 and the called multimode radio terminal 13 is terminated. That is, the radio interface becomes idle.

(Interface Setup)

Next, an interface setup is described where if it is necessary to switch the radio access network, an IP connection is made between the access point of the target radio access network and the access network server of the ISP 15 in order to allow the multimode radio terminal 13 to maintain communication without interruption.

When the calling and called multimode radio terminals 13 are communicating with each other, the agent portion 20c of the calling multimode radio terminal 13 is monitoring the receiving status of that communication. If switching is made to a dissimilar radio access network, the agent portion 20c detects it before the ongoing communication is disconnected, as described hereinabove. The agent portion 20c performs beforehand an interface setup for IP connection between the access point of the target radio access network and the access network server of the ISP 15, before the session parameters are updated.

First, the agent portion 20c employs the radio IF that is in the standby condition or is currently used for communication to send to the CCN server 12a the location information of the radio terminal 13; the IP interface employed by the radio terminal 13, that is, the type of the first through fourth radio IF 21-24; and destination information including the address thereof (information related to the target radio access network).

According to said destination information, the CCN server 12a identifies the server of the ISP 15 for the IP connection with the access point of the target radio access network.

The CCN server 12a then requests the server provided by the identified ISP 15 issue a service advance ticket as ad-hoc authentication information for enabling beforehand an interface setup with said radio terminal 13. The service advance ticket is comprised of a specific ID and an electronic signature against the ID, issued by ISP 15. If the communication is initiated after authentication when an IP communication service is to be received, a service connection may be hampered; thus, when an IP connection is to be made, sending the advance ticket permits the IP communication to be initiated, with the negotiations skipped. Accordingly, official authentication is performed sa needed during communication.

When the service advance ticket is issued, the CCN server 12a sends the information required for IP connection to said radio terminal 13. The information required for IP connection includes DHCP (Dynamic Host Configuration Protocol) information, PPPoE (Point to Point Protocol over Ethernet®) information, PPP (Point to Point Protocol) information and said service advance ticket. The DHCP information further includes an IP address, an IP subnet mask, a broadcast address, a DNS (Domain Name System) server address, a router IP address, a lease period of the address, and a destination address for updating the address. The PPPoE information includes an MAC (Media Access Control) information and NCP (Network Control Protocol) information. The CCN server 12a stores in the database the information required for IP connection excluding the service advance ticket, so that information required for a certain interface setup is extracted corresponding to the ISP 15 to be connected.

When the radio terminal 13 received the information required for interface setup from the CCN server 12a, the agent portion 20c of the radio terminal 13 sends said service advance ticket to the access network server of the ISP 15 for IP connection with the access. point of the target radio access network. It should be appreciated that for the access network server of the ISP 15 connected to the access point of the wireless LAN 11b, the radio terminal 13 sends the service advance ticket when the carrier is sensed and thus the communication is possible. Furthermore, for the ISP 15 connected to the access point of the cellular phone network 11d, the radio terminal 13 dials the access point thereof to send the service advance ticket thereto.

Upon receiving the service advance ticket, the access network server of the ISP 15 recognizes it as the service advance ticket that was previously issued at the ISP 15 to the CCN server 12a, and activates the connection with the radio terminal 13. The radio terminal 13 then employs the information required for interface setup that was sent from the CCN server 12a to make IP communication with the ISP 15 and perform interface setup. It should be appreciated that authentication is performed again during communication after switching, by use of CHAP (Challenge Handshake Authentication Protocol) or the like.

Accordingly, IP connection between the access point of the target radio access network and the access network server of the ISP 15 becomes ready during switching of the radio access network, so that the session can be maintained without interruption to the communication.

Next, the features of the present embodiment so configured are described below. (1) With the present embodiment, the multimode radio terminal 13 includes the call control portion 31, session management portion 32, profile management portion 33, and resource management portion 34, so that information related to the radio IF 21-24 and application 25-27 is stored and maintained therein. Additionally, by collaborating with the CCN server 12a over the Internet 12, the radio IF 21-24 and application 25-27 for use in communication can be selected efficiently.

(2) With the present embodiment, the multimode radio terminal 13 retains the information regarding the established session in the call control portion 31, session management portion 32, profile management portion 33, and resource management portion 34, and by combining it with the SIP function, it can sense the termination of the media session established by the session management portion 32. The session management portion 32 can then forcefully terminate the IP session via the call control portion 31, etc.

(3) With the present embodiment, selection of the radio network 11a-11d is performed by the multimode radio terminal 13. Thus, the bothersome need to send the radio IF and user information to the network is eliminated as compared to when it is selected on the network side, so that the signaling traffic can be reduced.

(4) With the present embodiment, because the multimode radio terminal 13 includes the call control portion 31, session management portion 32, profile management portion 33, and resource management portion 34, changes associated with increases/decreases of replacements of the applications and radio IFs can be easily accomplished as needed on the multimode radio terminal 13 side, that is, on the user's side.

(5) With the present embodiment, because the CCN server 12a is merely added over the Internet 12, only a little modification of change is needed to the existing radio network facilities.

(6) With the present embodiment, before the radio access network is switched, interface setup is performed beforehand for IP connection on the access network server of the ISP 15 to be connected to the access point of the target radio access network. Thus, IP connection during switching of the radio access network can be set up in a short time. The disconnect time based on the switching can be shortened.

It should be appreciated that the embodiment of the present invention may be altered in the following manner. In the afore-described embodiment, negotiation is conducted via the paging network 11c that is set as a signaling network; however, it is not limited thereto, but it may be conducted via a radio network that is not used and is communicable via carrier-sense, for example. Of course, negotiation may be conducted beforehand via the target radio network.

In the aforedescribed embodiment, a multimode radio terminal is employed as a radio terminal; however, it may be implemented by a SDR (Software Defined Radio) terminal.

As detailed above, according to the radio terminal session method of the present invention, a MIRAI network may be realized without imposing a burden on each of the radio access networks.

Furthermore, according to the interface setup method of the present invention, the IP connection during switching of a dissimilar radio access network can be set up quickly.

### DESCRIPTION OF THE REFERENCE SYMBOLS

—10 Multimedia Integrated network by Radio Access Innovation (MIRAI)
11—heterogeneous radio access networks
12—Internet
13—multimode radio terminal (MUT)
11a—PHS network
11b—wireless LAN (WLAN)
11c—paging network as a signaling network
12a—CCN server
20a—interface portion
20b—application portion
20c—agent portion
21—radio interface for PHS (1st wireless IF)
22—radio interface for paging (2and wireless IF)
23—radio interface for wireless LAN (3rd wireless IF)
24—radio interface for cellular phone (4th wireless IF)
25—voice application
26—video application
27—message application
31—call control portion
32—session management portion
33—profile management portion
34—resource management portion

1. A session control method for radio terminals used in a Multimedia Integrated network by Radio Access Innovation (MIRAI) that comprises a plurality of dissimilar radio access networks and the Internet that connects among said radio access networks, wherein
one of said radio access networks is employed as a signaling network;
a server is provided in said Internet such that when a request or connection with said radio terminal is made, session-related information required for the connection is sent to said signaling network;
said radio terminal includes a plurality of radio interfaces and a plurality of applications, as well as an agent portion; and
said agent portion allows a radio interface corresponding to said signaling network among a plurality of radio interfaces to be retained in the standby condition, and allows the radio interface in the standby condition to receive said session-related information, so that an application and radio interface that are suitable for communication are selected among said plurality of applications and said plurality of radio interfaces, respectively, based on said session-related information, to establish a session.

2. A session control method for radio terminals according to claim 1, where in the agent portion has the function to terminate the session upon completion of the communication and automatically set the radio interface in the idle state when it is no longer needed.

3. AN interface setup method for a Multimedia Integrated network by Radio Access Innovation (MIRAI) that comprises a plurality of dissimilar radio access networks and the Internet that connects among said radio access networks, wherein:
a server is located in said Internet to acquire ad-hoc authentication information against an access network server of each service provider that make IP connection respectively with an access point of said radio access network;
a radio terminal is equipped with a plurality of radio interfaces, as well as an agent portion;
said interface setup method comprising the steps of:
detecting beforehand, by said agent portion, switching of the radio access beforehand, by said agent portion, switching radio access network, sending information related to the target radio access network to said server located in the Internet;
identifying, by said server located in the Internet, said access network server that makes IP connection with the access point of the target radio access network, abased on said information related to the target radio access network; acquiring ad-hoc authentication information against the access network server; and sending information required for IP connection, together with the ad-hoc authentication information, to said agent portion;
sending, by said agent portion, said ad-hoc authentication information to said access network server, so that said ad-hoc authentication information activate connection with said access network server; and
sending by said agent portion, information required for IP connection to said access network to make IP connection, when connection to said access network server is activated.
